(19) United States
(12) Patent Application Publication
(10) Pub. No.: US 2007/0084163 A1
(43) Pub. Date: Apr. 19, 2007

(54) Movable air duct device

(76) Inventor: Vincent Lai, Taoyuan Hsien (TW)

Correspondence Address: PRO-TECHTOR INTERNATIONAL SERVICES, 20775 NORADA CT., SARATOGA, CA, 95070, US

(21) Appl. No.: 11/251,176

(22) Filed: Oct. 13, 2005

(51) Int. Cl. B01D 50/00

(52) U.S. Cl. 55/385.6

(57) ABSTRACT

A movable air duct device having an air duct installed on ventholes defined in a side panel of a computer case, wherein the air duct is connected to a duct base, and the duct base is used to insert within slide grooves of an inner frame to secure position thereof. The air duct can be displaced on the ventholes; thus, the movable air duct device is applicable for use on CPUs disposed at different positions. Moreover, the air duct can be lengthened and shortened on an annular tube of the duct base to accommodate CPUs of different height.

### BACKGROUND OF THE INVENTION

(a) Field of the Invention

The present invention relates to an improved movable air duct device, and more particularly to a movable air duct device that can function in coordination with CPUs (central processor units) disposed at different positions on different motherboards.

(b) Description of the Prior Art

A conventional heat sink device primarily comprises fins and a fan, wherein the fan is positioned on top of the fins. Wind power from the fan is used to expel heat produced by the CPU (central processor unit). However, the hot air produced by the CPU and peripheral chips circulates within the space interior of a computer case and is unable to be completely expelled. Hence, operators have installed an air duct on a side panel of the computer case. The air duct connects to the CPU disposed on a motherboard, and air from an outer side of the air duct is used to reduce the amount of hot air produced by the CPU. However, air ducts currently on the market are all fixed, unmovable devices, and, because the CPU is disposed at a different position in each personal computer depending on the motherboard used, thus, a fixed type air duct is unable to be used.

### SUMMARY OF THE INVENTION

The main objective of the present invention is to provide an air duct that is movable on a venthole of a side panel of a computer case, thereby enabling the air duct to function in coordination with CPUs (central processor units) disposed at different positions on different motherboards.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an exterior structural view according to the present invention.

FIG. 2 shows an exploded elevational view according to the present invention.

FIG. 3 shows a front plane view depicting a partial structure according to the present invention.

FIG. 4 shows an exploded elevational view of an air duct and duct base according to the present invention.

FIG. 5 shows an assembled elevational view of the air duct and duct base according to the present invention.

### DETAILED DESCRIPTION OF THE PREFERRED EMBODIMENTS

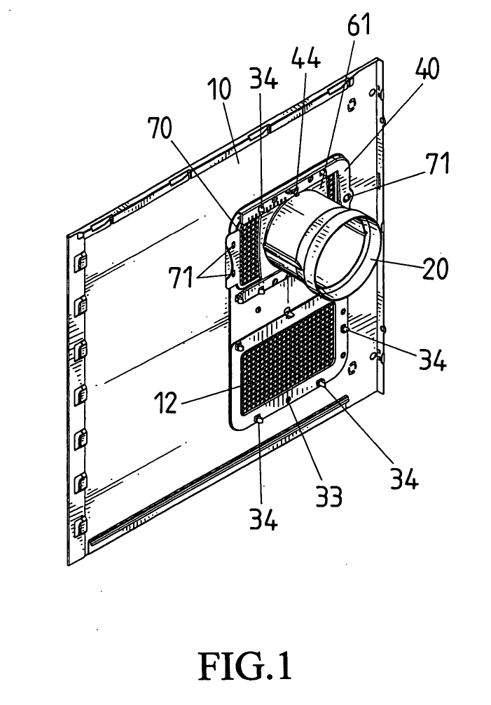

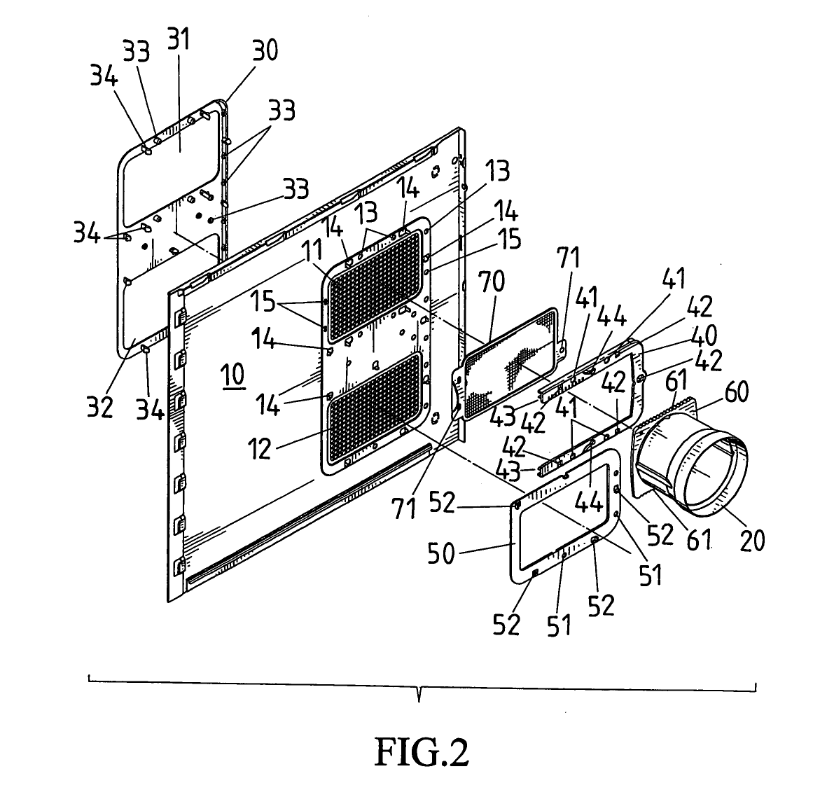

Referring to FIGS. 1 and 2, which show a movable air duct device of the present invention, wherein two ventholes 11, 12 are defined in a side panel 10 of a computer case. The venthole 11 provides for installing an air duct 20 therein, which connects to a CPU disposed on a motherboard (not shown in the drawings). Air from an outer side of the air duct 20 is used to naturally reduce hot air produced by the CPU. The present invention is characterized in that:

The air duct 20 is movable on the venthole 11, thereby enabling the air duct 20 to function in coordination with CPUs (central processor units) disposed at different positions on different motherboards. The movable air duct device of the present invention comprises an outer frame 30, two inner frames 40, 50 and a duct base 60 having the air duct 20 connected thereto. The outer frame 30 is positioned on an outer side of the side panel 10. Two through holes 31, 32 are defined in the outer frame 30 corresponding to the ventholes 11, 12 of the side panel 10 respectively. A plurality of insert pieces 33 and hooks 34 are configured on the outer frame 30. The insert pieces 33 and the hooks 34 penetrate a plurality of insert holes 13 and hook holes 14 defined in the side panel 10 respectively. A plurality of insert holes 41, 51 and hook holes 42, 52 are defined in the inner frames 40, 50 respectively, which provide for the insert pieces 33 and the hooks 34 of the outer frame 30 to insert and secure position therein.

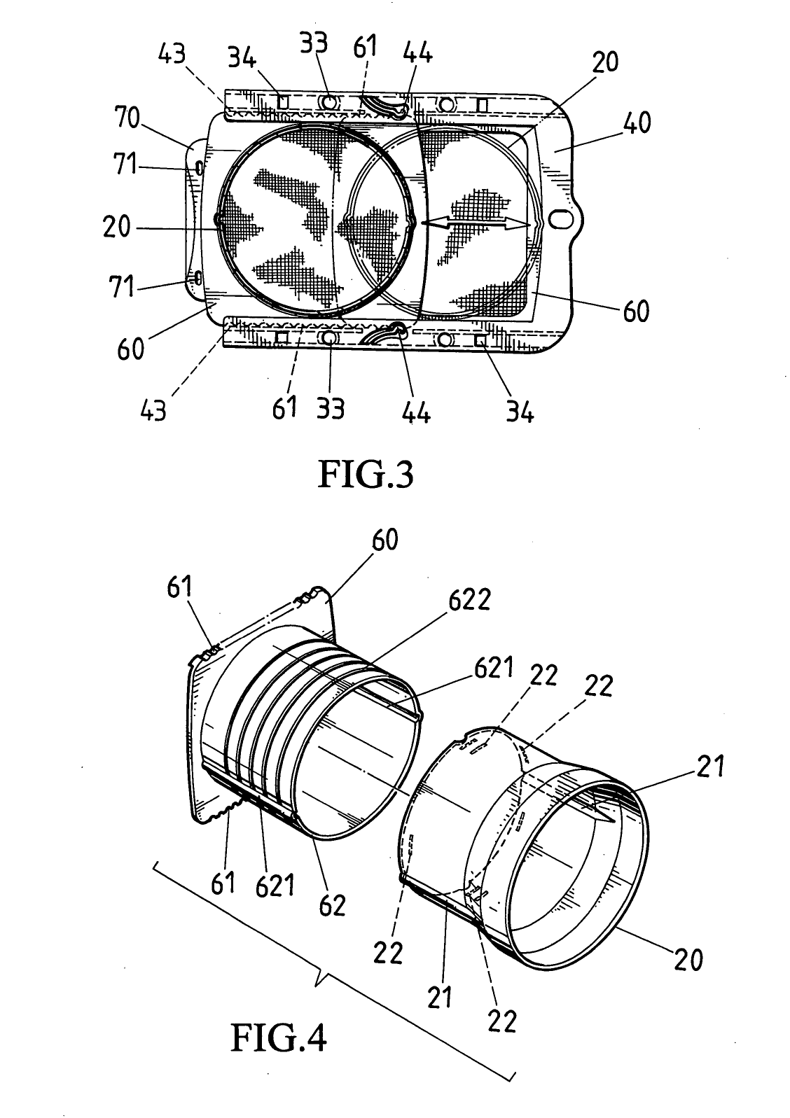

Referring to FIGS. 2 and 3, slide grooves 43 are respectively defined on two sides of an opening of the C-shaped inner frame 40. An elastic catch hook 44 is respectively configured within the two slide grooves 43 of the inner frame 40. Toothed grooves 61 are defined on edges of two sides of the duct base 60, which provide for the catch hooks 44 to clamp therein. Because the catch hooks 44 are provided with elasticity, thus, when the duct base 60 is displaced by force being applied thereto, the catch hooks 44 are forced to retract, thereby enabling the duct base 60 to move. When the force being applied to the duct base 60 is removed, the catch hooks 44 thereupon clamp within the toothed grooves 61.

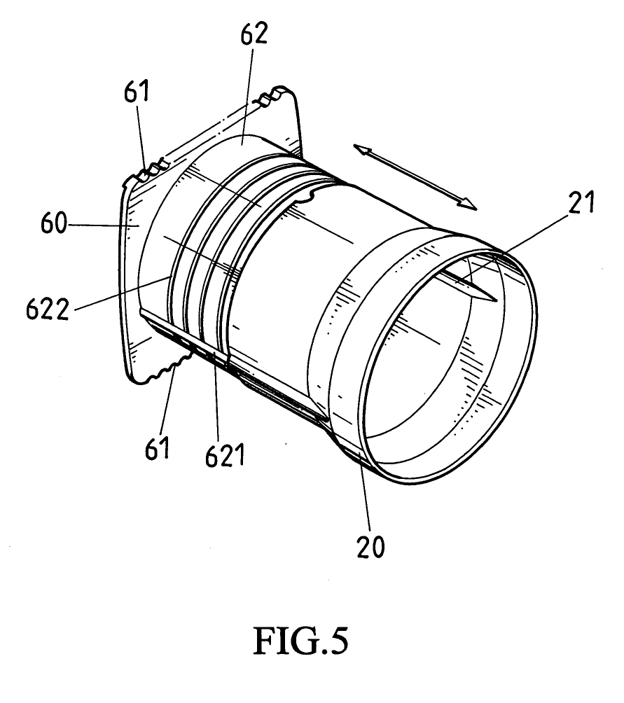

Referring to FIGS. 4 and 5, which show an embodiment of the present invention depicting a structure assembled from the air duct 20 and the duct base 60, wherein two protruding columns 621 and a plurality of annular ringed grooves 622 are configured on an annular tube 62, and two catch grooves 21 are defined on an inner side of the hollow air duct 20, which provide for the protruding columns 621 of the annular tube 62 to respectively clamp therein, thereby enabling the air duct 20 to lengthen and shorten on the annular tube 62. A plurality of catch strips 22 are configured within a front end of the air duct 20, which can clamp within the ringed grooves 622 of the annular tube 62 to secure position thereof. Caliber of the air duct 20 can be adjusted according to height of the CPU.

Referring to FIGS. 1 and 2, a filter screen 70 can be disposed between the venthole 11 and the duct base 60 to filter out dust. The filter screen 70 is inserted into the slide grooves 43 of the inner frame 40. Location holes 71 respectively defined in a front and rear end of the filter screen 70 provide for location protrusions 15 on the side panel 10 to clamp therein.

In conclusion, the movable air duct device of the present invention provides an air duct 20 that is able to change position depending on position of the CPU disposed on a motherboard, and is thus applicable for use on CPUs disposed at different positions on different motherboards. Moreover, the air duct 20 can be lengthened and shortened according to height of the CPU.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A movable air duct device comprising an air duct installed on ventholes defined in a side panel of a computer case, the air duct connects to a CPU (central processing unit) disposed on a motherboard; the movable air duct device is characterized in that:
the air duct device comprises:
an outer frame, within which are defined through holes corresponding to the ventholes of the side panel, a plurality of insert pieces and hooks are configured on the outer frame;
an inner frame, on which are defined are a plurality of insert holes and hook holes, which provide for the insert pieces and hooks of the outer frame to securely insert therein;
a duct base, which connects to the air duct, and two sides of the duct base are configured with toothed grooves; the duct base inserts into slide grooves of the inner frame, and catch hooks of the inner frame provide for clamping and securing position within the toothed grooves;
whereby the assembled air duct uses the duct base to move within the slide grooves of the inner frame.

2. The movable air duct device according to claim 1, wherein one end of the duct base is provided with an annular tube; two protruding columns and a plurality of ringed grooves are configured on the annular tube, two catch grooves of an inner side of the air duct provide for the two protruding columns of the annular tube to clamp therein, and catch strips of the inner side of the air duct provide for clamping within the ringed grooves of the annular tube to secure position.

3. The movable air duct device according to claim 1, wherein a filter screen is inserted into the slide grooves of the inner frame and disposed between the air duct and the duct base; location holes defined in the filter screen provide for location protrusions configured on the side panel to securely embed therein.
